(19) United States
(12) Patent Application Publication
(10) Pub. No.: US 2021/0312386 A1
(43) Pub. Date: Oct. 7, 2021

(54) METHOD AND SYSTEM FOR FACILITATING IN-TRANSIT PURCHASE OF PRODUCTS

(71) Applicant: Mastercard International Incorporated, Purchase, NY (US)

(72) Inventors: Rajeev Kumar, Varanasi (IN); Abhay Mandloi, Pune (IN); Raju Kumar Gupta, Pune (IN)

(73) Assignee: Mastercard International Incorporated, Purchase, NY (US)

(21) Appl. No.: 17/198,514

(22) Filed: Mar. 11, 2021

(30) Foreign Application Priority Data
Apr. 3, 2020 (IN) 202021014857

(51) Int. Cl. G06Q 10/08; G06Q 20/40

(52) U.S. Cl. CPC G06Q 10/0836; G06Q 10/0833; G06Q 20/401; G06Q 10/0835; G06Q 10/0832

(57) ABSTRACT

A method for facilitating in-transit purchase of products includes receiving, by a server from a user device, route information of a route being traversed by a user in a vehicle and a current location of the transport vehicle. Based on the route information and the current location, the server recommends, to the user, a product available for purchase and a pickup location for collecting the product. The server receives, from the user, an order request indicative of the product, the pickup location, and an identifier of a radio frequency tag placed in the vehicle. Upon acceptance of the order request, the server initiates blocking of a transaction amount associated with the product from a payment account that is linked to the identifier. When the product is collected by the user from the pickup location, the server initiates a deduction of the blocked amount from the payment account.

### CROSS REFERENCE TO RELATED APPLICATIONS

This application claims priority to Indian Application Serial No. 202021014857, filed Apr. 3, 2020, which is incorporated herein by reference in its entirety

### BACKGROUND

### Field of the Disclosure

Various embodiments of the disclosure relate generally to electronic transactions. More particularly, various embodiments of the present disclosure relate to a method and a system for facilitating in-transit purchase of products.

### Description of the Related Art

Shopping, today, constitutes an integral part of day to day life of any user. Traditionally, shopping was constrained by users having to visit brick-and-mortar stores for making purchases. Advancements in technology have led to the advent of online shopping (i.e., e-commerce), allowing users to make purchases from the convenience of a home or a workplace.

However, online shopping fails to cater to any user who wishes to purchase and collect a product, while traversing a route. Online shopping, currently, lacks a capacity to facilitate delivery to a user in transit, based on a trajectory of the user. Currently, a user who is transiting along a route may intend to purchase a product (e.g., food, apparel, or the like). However, the user may be required to deviate from the route to purchase and/or collect the product. For example, the user may be required to deviate from the route to purchase food from a takeout restaurant that may be situated at a location proximate to the route. Such a deviation may add to a travel time and increase a fuel cost of the user, thus heavily inconveniencing the user.

In light of the foregoing, there is a need for a technical solution that enables easy and convenient purchase of products by a user who is travelling along a specific route.

### SUMMARY

In an embodiment of the present disclosure, a method for facilitating in-transit purchase of products is provided. The method includes receiving, by an application server, from a user device of a user, route information of a route being traversed by the user in a transport vehicle and a current location of the transport vehicle on the route. A set of products available for purchase and a set of pickup locations on the route for collecting the set of products are recommended to the user by the application server by way of the user device. The set of products and the set of pickup locations are recommended based on the received route information and the received current location. An order request is received by the application server from the user device. The order request is indicative of a first product selected by the user from the set of products for purchase, a first pickup location selected by the user from the set of pickup locations for collecting the first product, and an identifier of a radio frequency (RF) tag placed in the transport vehicle. Upon acceptance of the received order request, blocking of a transaction amount from a first payment account that is linked to the identifier is initiated by the application server. The transaction amount is associated with the first product. Deduction of the blocked transaction amount from the first payment account is initiated by the application server when the transport vehicle is detected at the first pickup location and the first product is delivered to the first pickup location. The first product is collected by the user from the first pickup location.

In another embodiment of the present disclosure, a system for facilitating in-transit purchase of products is provided. The system includes an application server configured to receive, from a user device of a user, route information of a route being traversed by the user in a transport vehicle and a current location of the transport vehicle on the route. The application server recommends, to the user by way of the user device, a set of products available for purchase and a set of pickup locations on the route for collecting the set of products. The set of products and the set of pickup locations are recommended based on the received route information and the received current location. The application server receives an order request from the user device. The order request is indicative of a first product selected by the user from the set of products for purchase, a first pickup location selected by the user from the set of pickup locations for collecting the first product, and an identifier of a radio frequency (RF) tag placed in the transport vehicle. The application server initiates, upon acceptance of the received order request, blocking of a transaction amount associated with the first product from a first payment account that is linked to the identifier. The application server initiates deduction of the blocked transaction amount from the first payment account when the transport vehicle is detected at the first pickup location and the first product is delivered to the first pickup location. The first product is collected by the user from the first pickup location.

### BRIEF DESCRIPTION OF DRAWINGS

Various embodiments of the present disclosure are illustrated by way of example, and not limited by the appended figures, in which like references indicate similar elements, and in which:

FIG. 1 is a block diagram that illustrates an exemplary environment for facilitating in-transit purchase of products, in accordance with an exemplary embodiment of the present disclosure;

FIG. 2 represents a schematic diagram that illustrates a route traversed by a user in a transport vehicle of FIG. 1, in accordance with an exemplary embodiment of the present disclosure;

FIGS. 3A-3G, collectively represent a process flow diagram that illustrates facilitation of in-transit purchase of products by an application server of FIG. 1, in accordance with an exemplary embodiment of the present disclosure;

FIGS. 4A-4G, collectively represent a process flow diagram that illustrates facilitation of in-transit purchase of products by the application server, in accordance with another exemplary embodiment of the present disclosure;

FIGS. 5A and 5B, collectively represent an exemplary scenario that illustrates user interface (UI) screens rendered on a user device of FIG. 1 for facilitating in-transit purchase of products, in accordance with an exemplary embodiment of the present disclosure;

FIG. 6 is a block diagram that illustrates the application server, in accordance with an exemplary embodiment of the present disclosure;

FIG. 7 is a block diagram that illustrates a system architecture of a computer system, in accordance with an exemplary embodiment of the present disclosure;

FIGS. 8A-8D, collectively represent a flow chart that illustrates a method for facilitating in-transit purchase of products, in accordance with an exemplary embodiment of the present disclosure; and

FIG. 9 represents a high-level flow chart that illustrates a method for facilitating in-transit purchase of products, in accordance with an exemplary embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION OF EMBODIMENTS

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

Users who are travelling in a transport vehicle may be required to deviate from their route for purchasing and/or collecting products. In other words, a user traversing a route may need to be in a vicinity or proximity of a merchant to purchase a product, often requiring the user to deviate from the route. Such deviations may lead to increased travel times and fuel costs for the users, thus heavily inconveniencing the users.

Various embodiments of the present disclosure provide a method and a system that solve the abovementioned problem by leveraging RF technology to facilitate in-transit purchase of products. The system of the present disclosure includes an application server that may receive from a user device of a user, route information of a route being traversed by the user in a transport vehicle and a current location of the transport vehicle on the route. Based on the received route information and the current location, the application server may recommend to the user, by way of the user device, a set of products available for purchase and a set of pickup locations on the route for collecting the set of products. The user may initiate an order request by selecting a first product from the set of products for purchase and a first pickup location from the set of pickup locations for collecting the first product. The user device may communicate the order request to the application server. The order request may be indicative of the first product, the first pickup location, and an identifier of an RF tag placed in the transport vehicle. The identifier of the RF tag may be linked to a first payment account of the user. The application server may receive the order request from the user device. Based on an acceptance of the order request, the application server may initiate blocking of a transaction amount, associated with the first product, from the first payment account. The first product may be delivered to the first pickup location. Following a detection of the transport vehicle at the first pickup location and the collection of the first product by the user from the first pickup location, the application server may initiate a deduction of the blocked transaction amount from the first payment account.

In one embodiment, the first pickup location may correspond to a toll collection station. In such scenarios, the application server may initiate a deduction of a corresponding toll fee amount from the first payment account, in addition to the transaction amount.

Thus, the method and system of the present disclosure facilitates easy and convenient in-transit purchase of the first product using RF technology. The RF technology provides a seamless mode of payment for purchasing the first product, while the user is travelling in the transport vehicle.

### TERMS DESCRIPTION (IN ADDITION TO PLAIN AND DICTIONARY MEANING)

Payment account of a user refers to a financial account of the user maintained at a financial institution or an entity such as an issuer. The user may use the payment account to perform one or more financial transactions, such as purchase transactions for one or more products. Examples of the payment account may include a savings account, a current account, a digital wallet account, or the like.

Radio frequency (RF) tag is an electronic tag that exchanges data with an RF reader through radio waves. The RF tag may include an antenna for transmitting and receiving radio waves and an integrated circuit for storing and processing the data. The RF tag may be associated with a unique identifier (e.g., alphanumeric identifier), which is stored in the RF tag. The RF tag may be placed in a transport vehicle and linked to a payment account of a user, for automatic payment of toll fee amounts at toll stations.

RF reader is an electronic device that is used to read information stored in an RF tag. The RF reader may interact with the RF tag, which is in proximity to the RF reader, to read or acquire an identifier of the RF tag.

Route refers to a path traversed by a user in a transport vehicle for traveling from one location to another location. For example, when the user is travelling from a first location to a second location in the transport vehicle, the route refers to the path between the first location and the second location.

Route information includes information pertaining to a route that is to be traversed or is being traversed by a user in a transport vehicle. Route information of the route may include, but is not limited to, a source location of the route, a destination location of the route, details of one or more roads included in the route, or the like.

Transport vehicle is means of transport used by a user for traversing a route. Examples of the transport vehicle include a car, a bike, a bus, or the like. The transport vehicle may be privately owned or rented by the user for traversing the route.

Pickup location is an intermediate location on a route that is traversed by a user in a transport vehicle. The user may collect one or more purchased products from the pickup location. In one example, the pickup location is a toll collection station.

Order request is a request initiated by a user for purchasing one or more products. The order request is indicative of the products selected by the user for purchase and a pickup location selected by the user for collecting the selected products. The pickup location is an intermediate location of the route that is traversed by the user in a transport vehicle. The order request is further indicative of an identifier of an RF tag placed in the transport vehicle.

Server is a physical or cloud data processing system on which a server program runs. The server may be implemented in hardware or software, or a combination thereof. In one embodiment, the server may be implemented in computer programs executing on programmable computers, such as personal computers, laptops, or a network of computer systems. The server may correspond to one of an acquirer server, a payment network server, or an issuer server.

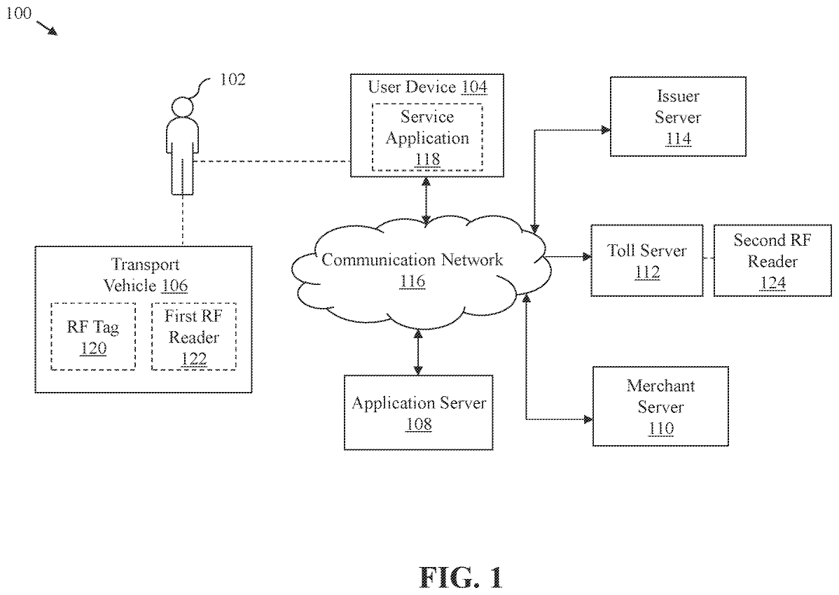

FIG. 1 is a block diagram that illustrates an exemplary environment 100 for facilitating in-transit purchase of products, in accordance with an exemplary embodiment of the present disclosure. The environment 100 includes a user 102, a user device 104, a transport vehicle 106, an application server 108, a merchant server 110, a toll server 112, and an issuer server 114. The user device 104, the transport vehicle 106, the application server 108, the merchant server 110, the toll server 112, and the issuer server 114 may communicate with each other by way of a communication network 116 or through separate communication networks established therebetween.

The user 102 may be an individual, who is associated with a first payment account that is maintained at a financial institution, such as an issuer. Examples of the first payment account may include a bank account, a savings account, a current account, a credit account, a digital wallet account, or the like. The user 102 may utilize the transport vehicle 106 for traversing a route. While in-transit along the route, the user 102 may purchase one or more products that are offered for sale by one or more merchants using the user device 104.

In one embodiment, the user device 104 may be a computing device of the user 102, such as a personal computer, a mobile phone, a smartphone, a tablet, a phablet, a laptop, or the like. In another embodiment, the user device 104 may be a vehicle unit (e.g., an infotainment unit or a navigation unit) of the transport vehicle 106. The user device 104 may be configured to run or execute various web or mobile applications such as a service application 118 hosted by the application server 108. While in-transit in the transport vehicle 106, the user 102 may purchase the products by accessing the service application 118 on the user device 104. The user device 104 may be equipped with global positioning system (GPS) functionality that facilitates real-time or near real-time location tracking of the user device 104.

The transport vehicle 106 may be a mode of transport (e.g., a car, a pickup truck, a van, or the like) that is used by the user 102 for traversing the route. The transport vehicle 106 may be a personal vehicle of the user 102 or a rented vehicle (e.g., a vehicle on lease, a self-driven rented vehicle, a chauffeured rented vehicle, or the like). The transport vehicle 106 may include an RF tag 120 (i.e., the RF tag 120 may be placed in the transport vehicle 106). For example, the RF tag 120 may be affixed to a windshield of the transport vehicle 106. The RF tag 120 may be associated with a unique identifier (e.g., an alphanumeric code) that is stored in a memory of the RF tag 120. The identifier of the RF tag 120 may be associated with (or linked to) the first payment account of the user 102. The RF tag 120 may be a passive RF tag or an active RF tag. The transport vehicle 106 may further include a first RF reader 122 for reading or acquiring the identifier of the RF tag 120 when the RF tag 120 is activated. Working of the RF tag 120 and the first RF reader 122 will be known to those of skill in the art.

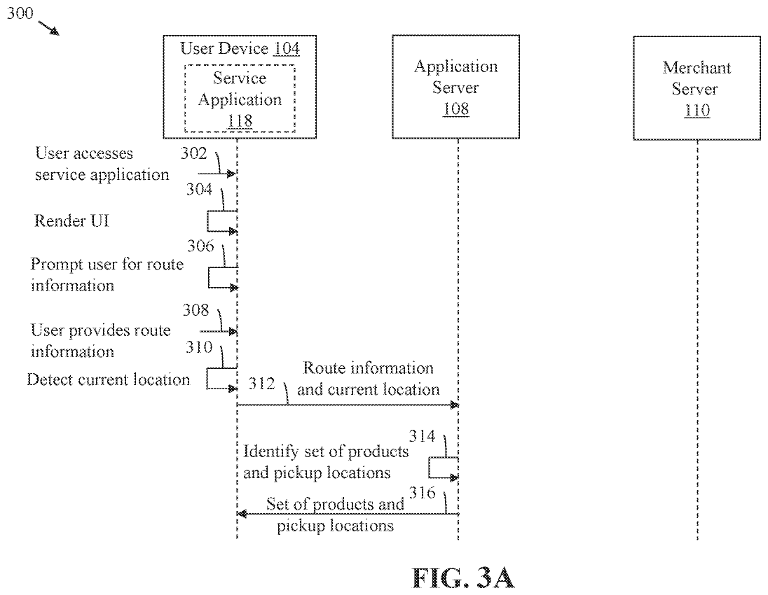

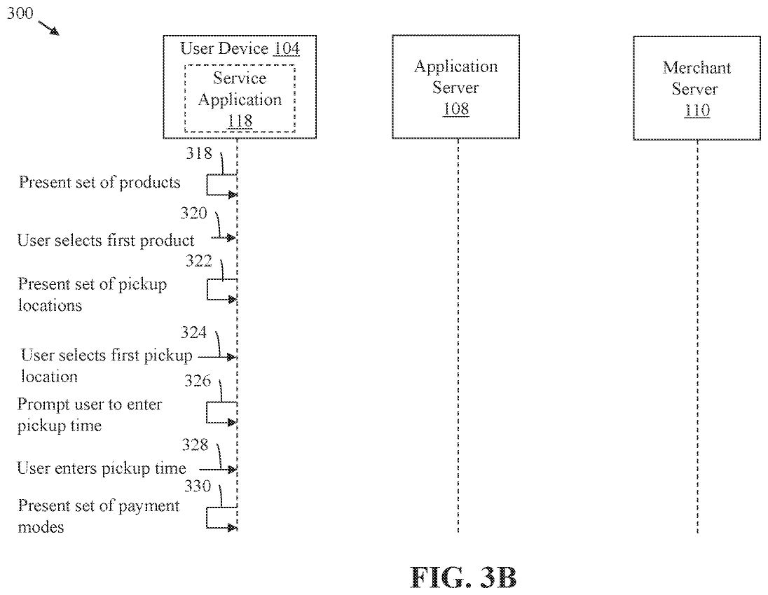

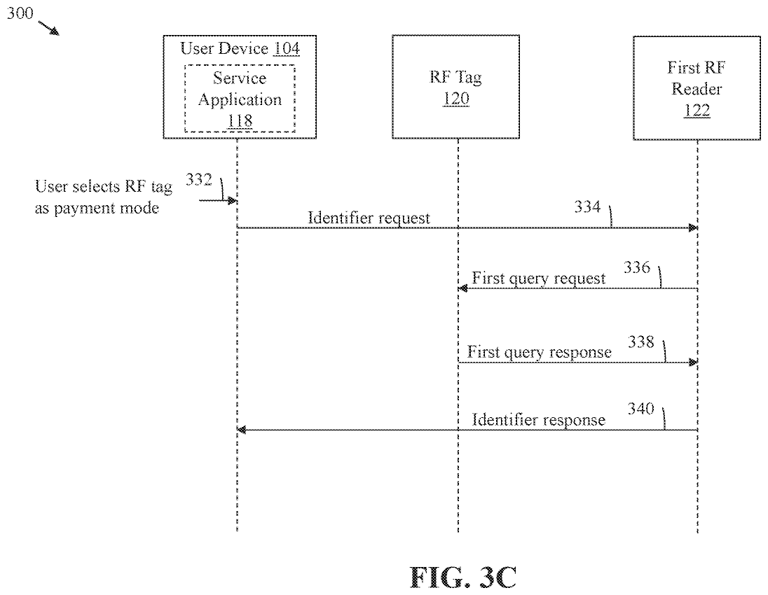

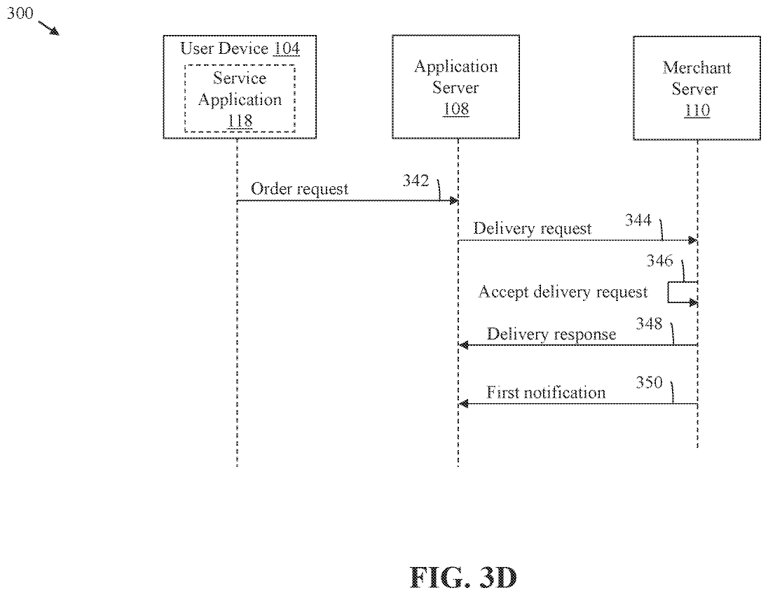

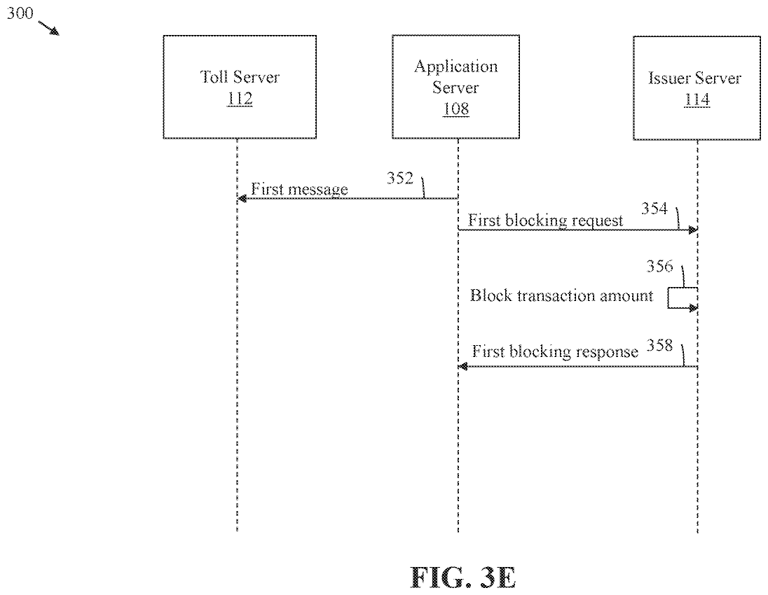

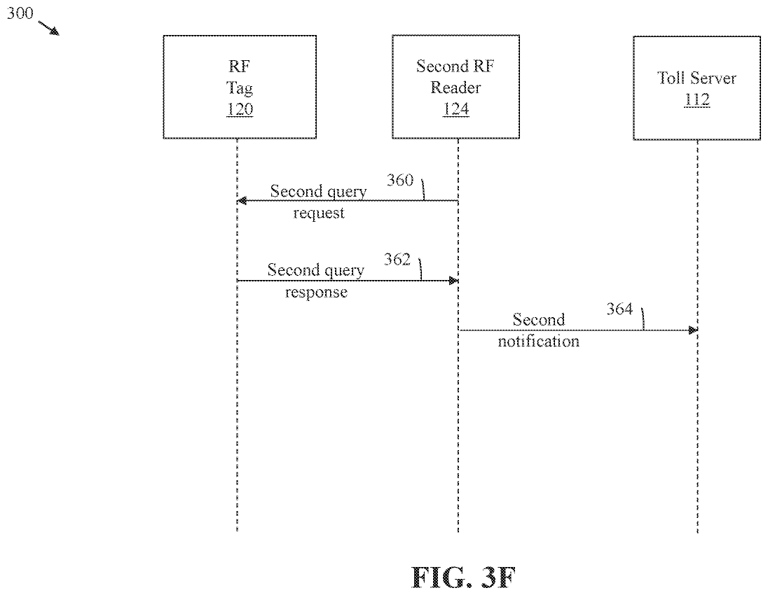

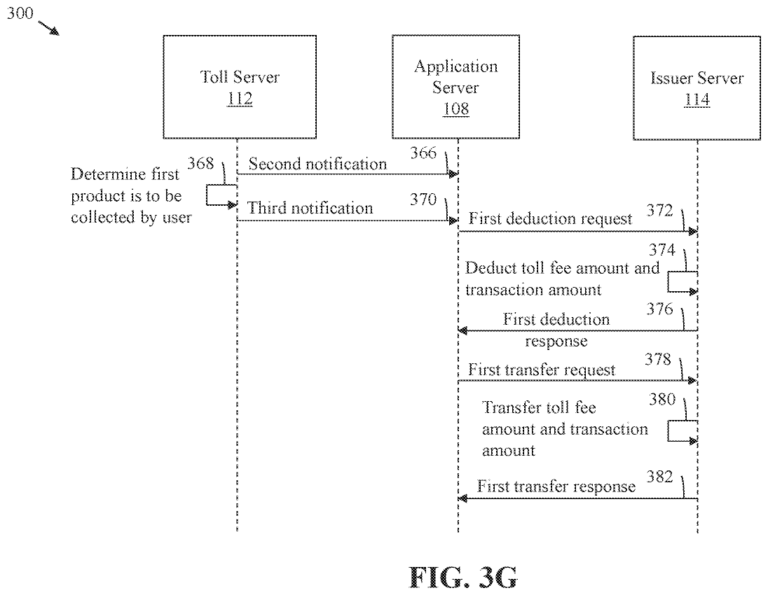

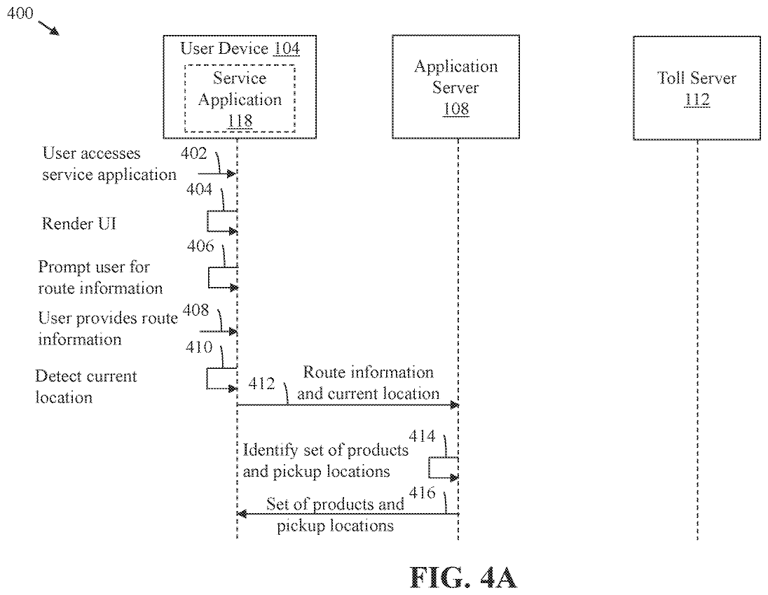

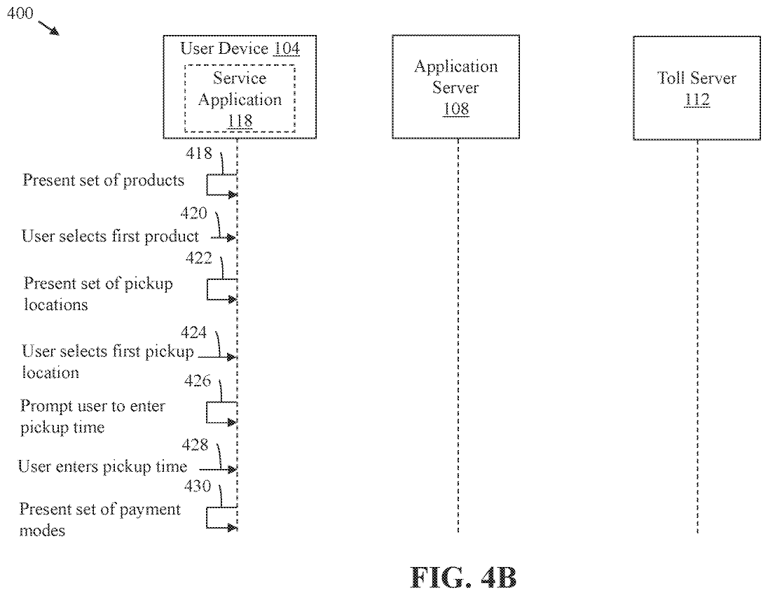

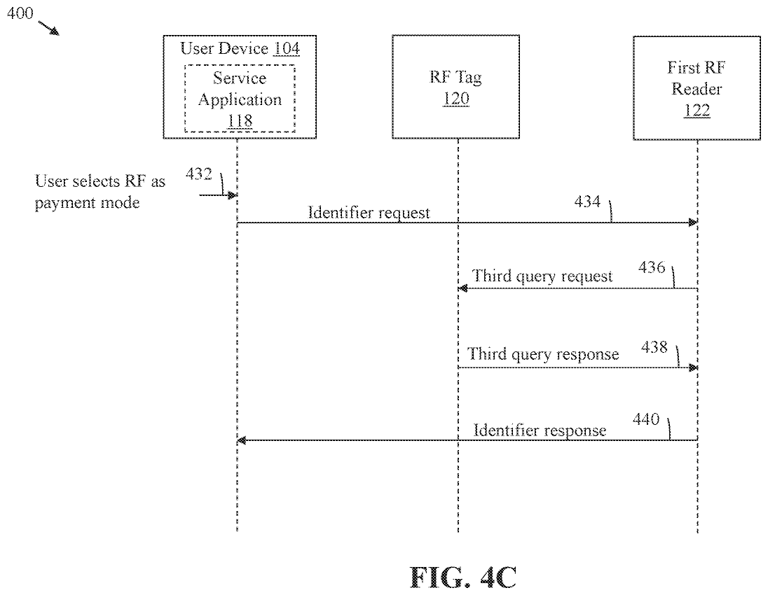

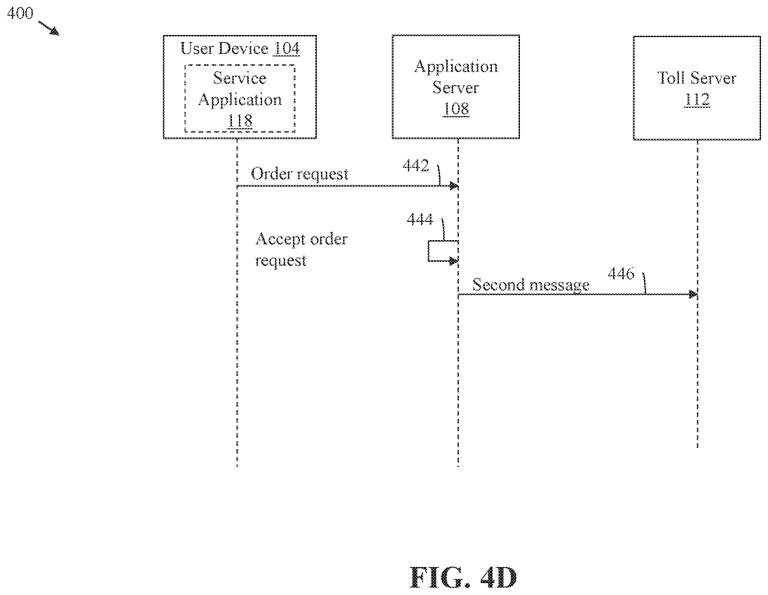

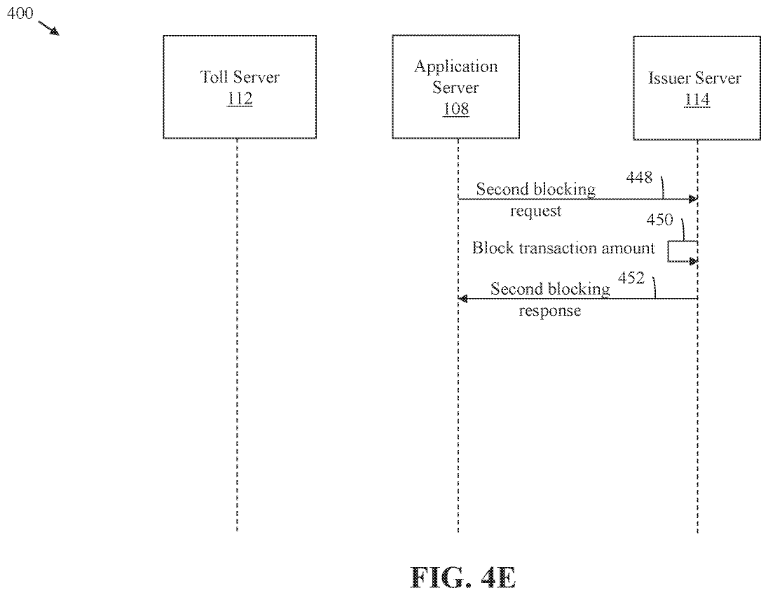

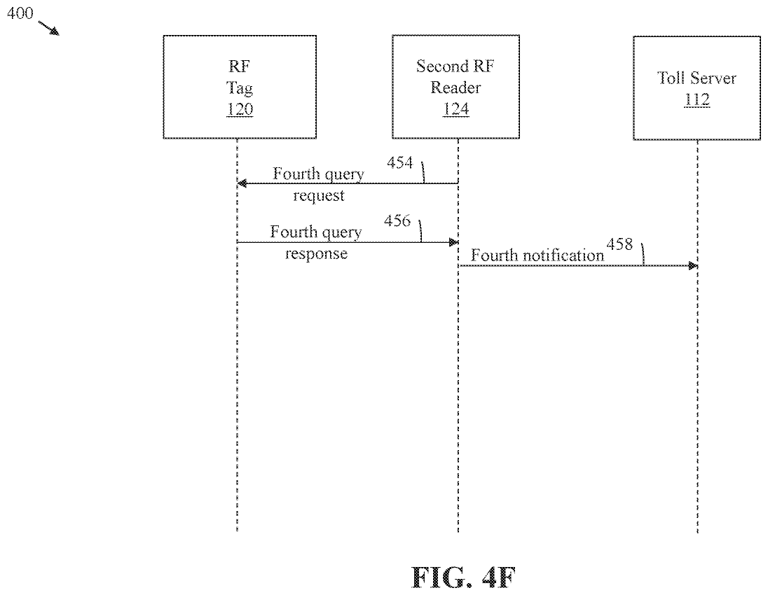

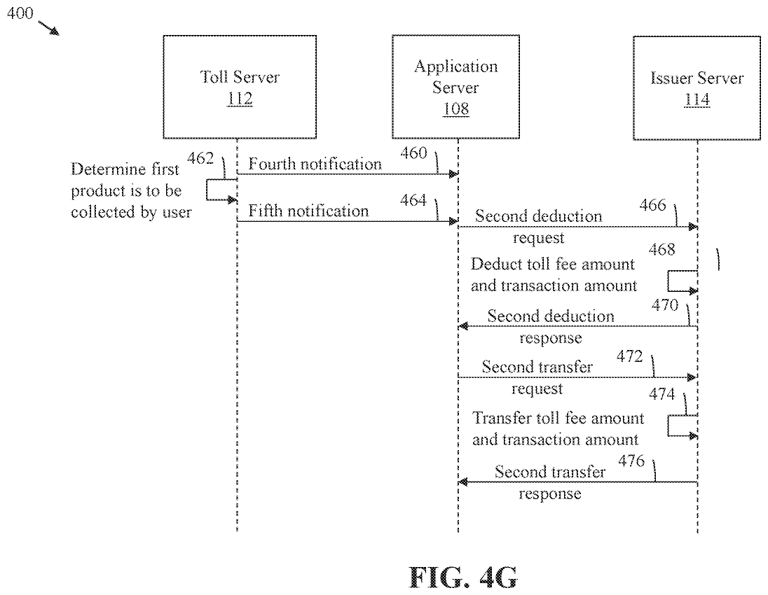

The application server 108 may be a computing server, which includes suitable logic, circuitry, interface, and/or code, executable by the circuitry, for facilitating in-transit purchase of products. The application server 108 may be operated by various entities such as, but not limited to, a merchant, an e-commerce organization, a ride service provider, a financial institution (e.g., a payment network or interchange, an acquirer, or the issuer), or the like. In one embodiment, the application server 108 may be a standalone server operated by the e-commerce organization or the ride service provider for enabling the user 102 to carry out in-transit purchase of products from various merchants. In another embodiment, the application server 108 may be operated by a merchant for enabling the user 102 to carry out in-transit purchase of products from the merchant. In another embodiment, the application server 108 may be operated by the payment network (e.g., Mastercard®) for facilitating in-transit purchase of products. The application server 108 may host the service application 118 that runs on the user device 104. Various operations performed by the application server 108 for enabling the user 102 to carry out in-transit purchase of products are described in detail in FIGS. 3A-3G and 4A-4G.

The merchant server 110 may be a computing server, which includes suitable logic, circuitry, interface, and/or code, executable by the circuitry, for facilitating purchase of products that are offered for sale. The merchant server 110 may be operated by a first merchant who offers the products (e.g., food products, electronics, apparel, or the like) for sale. The merchant server 110 may communicate, to the application server 108, a list (i.e., a catalogue) of the products that are offered for sale by the first merchant. The merchant server 110 may further communicate, to the application server 108, a location of each retail store, warehouse, and/or a delivery center of the first merchant. The merchant server 110 may further communicate, to the application server 108, a delivery radius associated with each retail store, warehouse, and/or delivery center. The first merchant may be associated with a second payment account. The second payment account may be maintained at an acquirer that is different from the issuer that operates the issuer server 114. However, for the sake of brevity, it is assumed that the second payment account is maintained at the issuer that operates the issuer server 114. The environment 100 depicts a single merchant server (i.e., the merchant server 110). However, it will be apparent to those of skill in the art that the environment 100 may include any number of merchant servers associated with any number of merchants, without deviating from the scope of the disclosure.

The toll server 112 may be a computing server, which includes suitable logic, circuitry, interface, and/or code, executable by the circuitry, for facilitating collection of toll amounts or toll fee amounts. The toll server 112 may be operated by a toll authority that maintains one or more RF-based toll collection stations, such as a first toll collection station. Hereinafter, ‘RF-based toll collection stations’ are interchangeably referred to as ‘toll collection stations’. As will be known to those of skill in the art, RF-based toll collection stations allow users who are travelling in transport vehicles to make toll fee payments seamlessly by leveraging the RF technology. Thus, the user 102 while traversing a route in the transport vehicle 106 is not required to halt the transport vehicle 106 at a toll collection station for making a toll fee payment. For seamless toll fee collection, each RF-based toll collection station may employ an RF reader to detect the transport vehicle 106 (i.e., acquire the identifier of the RF tag 120 placed in the transport vehicle 106) when the transport vehicle 106 transits through the RF-based toll collection station. For example, a second RF reader 124 is placed at the first toll collection station for detecting the transport vehicle 106 at the first toll collection station. When the transport vehicle 106 is detected at the first RF-based toll collection station, a corresponding toll fee amount, without requiring any manual input from the user 102, is automatically debited from the first payment account linked to the identifier of the RF tag 120. The toll authority may maintain a third payment account at an issuer for collecting toll fee amounts for transport vehicles that cross the first toll collection station or any other toll collection station associated with the toll authority. The third payment account may be maintained at an issuer other than the issuer that operates the issuer server 114. However, for the sake of brevity, it is assumed that the third payment account is maintained by the issuer that operates the issuer server 114.

In one embodiment, the toll server 112 may be a central server (i.e., a remote server) that communicates with the RF readers (e.g., the second RF reader 124) that are placed at various RF-based toll collection stations (e.g., the first toll collection station). In such a scenario, the toll server 112 may receive, from the RF readers, identifiers of RF tags (e.g., the identifier of the RF tag 120) placed in transport vehicles (e.g., the transport vehicle 106) that transit through the RF-based toll collection stations. In another embodiment, each RF-based toll collection station may be associated with a separate toll server.

The issuer server 114 may be operated by the issuer that maintains the first payment account of the user 102, the second payment account of the first merchant, and the third payment account of the toll authority. The issuer may be a financial institution that manages payment accounts of multiple users (such as the user 102) or entities (e.g., the first merchant and the toll authority). Details of the payment accounts established with the issuer may be stored as account profiles. Each account profile may be indicative of a transaction history of a corresponding user or entity. For example, a first account profile of the user 102 may be indicative of a transaction history of the user 102. The application server 108 may credit and debit the payment accounts based on transactions made by the users or entities from their corresponding payment accounts.

The communication network 116 is a medium through which content and messages are transmitted between the user device 104, the application server 108, the merchant server 110, the toll server 112, and the issuer server 114. Examples of the communication network 116 may include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 116 in accordance with various wired and wireless communication protocols, such as Transmission Control Protocol and Internet Protocol (TCP/IP), User Datagram Protocol (UDP), Long Term Evolution (LTE) communication protocols, or any combination thereof.

In operation, the user 102 may access the service application 118 running on the user device 104. The user 102 may provide, to the service application 118, route information of a route to be traversed or being traversed by the user 102 in the transport vehicle 106. Since the service application 118 running on the user device 104 is hosted by the application server 108, the service application 118 serves as a gateway to the application server 108. Thus, the route information provided by the user 102 to the service application 118 is received by the application server 108. The application server 108 may further receive, from the user device 104, a current location of the user device 104. The user device 104 may be carried by the user 102 who is traveling in the transport vehicle 106 or may be included within the transport vehicle 106. Therefore, the current location of the user device 104 may correspond to a current location of the transport vehicle 106. Based on the received current location and the received route information, the application server 108 may identify a set of products that are available for purchase along the route and a set of pickup locations along the route for collecting the set of products. Each pickup location of the set of pickup locations may correspond to an intermediate location on the route. For providing purchase recommendation to the user 102, the application server 108 may communicate the set of products and the set of pickup locations to the user device 104. In a non-limiting example, each pickup location of the set of pickup locations may be a toll collection station.

The service application 118 may render a user interface (UI) on a display of the user device 104. The set of products and the set of pickup locations may be displayed on the rendered UI for user selection. By utilizing the user device 104, the user 102 may select one or more products (e.g., a first product) from the set of products for purchase and a first pickup location from the set of pickup locations for collecting the selected one or more products. When the user 102 confirms the selection, the first RF reader 122 may read the identifier of the RF tag 120 and communicate the identifier to the user device 104. The service application 118 running on the user device 104 then initiates an order request for the purchase. The initiated order request may be indicative of the first product selected by the user 102 for purchase and the first pickup location (i.e., the first toll collection station) selected by the user 102 for collecting the first product. The order request may be further indicative of the identifier of the RF tag 120.

The user device 104 may communicate the order request to the application server 108. Upon acceptance of the order request, the application server 108 may initiate blocking of a transaction amount associated with the first product from the first payment account of the user 102. For example, the application server 108 may communicate a request to the issuer server 114 for blocking the transaction amount from the first payment account of the user 102. The issuer server 114 may block the transaction amount from the first payment account based on the received request. Consequently, the issuer server 114 may communicate a response, indicative of the blocking of the transaction amount, to the application server 108. Following the reception of the response from the issuer server 114, the application server 108 may communicate details of the order request and the identifier of the RF tag 120 to the toll server 112. The first product may be delivered to the first pickup location for collection by the user 102.

When the transport vehicle 106 reaches the first pickup location (i.e., the first toll collection station), the second RF reader 124 placed at the first pickup location may detect the presence of the transport vehicle 106 based on the identifier of the RF tag 120. The second RF reader 124 may communicate, to the toll server 112, a notification to indicate the detection of the transport vehicle 106 at the first pickup location (i.e., the first toll collection station). The toll server 112 may then communicate the notification to the application server 108. The toll server 112 may further communicate another notification to the application server 108 indicating that the first product is collected by the user 102. Consequently, the application server 108 may initiate deduction of the blocked transaction amount and a toll fee amount from the first payment account of the user 102. For example, the application server 108 may communicate a request to the issuer server 114 for deducting the blocked transaction amount and the toll fee amount from the first payment account of the user 102. Further, based on the request, the issuer server 114 may deduct the blocked transaction amount and the toll fee amount from the first payment account. The application server 108 may further initiate a transfer of the deducted transaction amount and the deducted toll fee amount to the second and third payment accounts of the first merchant and the toll authority, respectively.

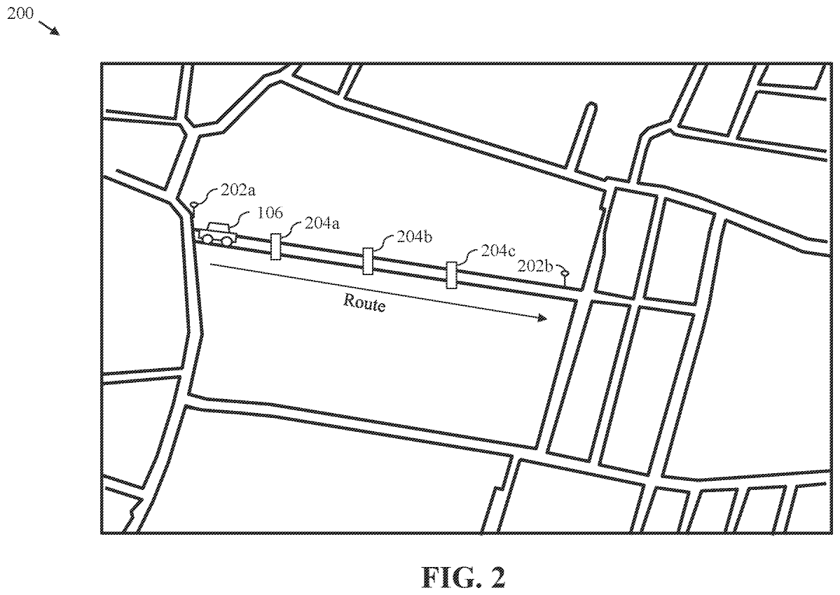

FIG. 2 represents a schematic diagram 200 that illustrates a route traversed by the user 102 in the transport vehicle 106, in accordance with an exemplary embodiment of the present disclosure. The route traversed by the user 102 in the transport vehicle 106 starts from a source location 202a and terminates at a destination location 202b. The route may be a highway, an expressway, a freeway, or the like. The route may include various designated pickup locations. For example, as shown in FIG. 2, the route includes three pickup locations, i.e., a first pickup location 204a, a second pickup location 204b, and a third pickup location 204c. Hereinafter, the first through third pickup locations are collectively referred to as ‘the set of pickup locations 204’. For the sake of brevity, it is assumed that each of the first through third pickup locations 204a-204c is a toll collection station. It will be apparent to a person of skill in the art that the route illustrated in FIG. 2 is for exemplary purpose and should not be construed to limit the scope of the disclosure.

FIGS. 3A-3G, collectively represent a process flow diagram 300 that illustrates facilitation of in-transit purchase of products by the application server 108, in accordance with an exemplary embodiment of the present disclosure. The process flow diagram 300 involves the user device 104, the transport vehicle 106, the application server 108, the merchant server 110, the toll server 112, and the issuer server 114. The process flow diagram 300 further involves the RF tag 120, the first RF reader 122, and the second RF reader 124. FIGS. 3A-3G are explained in conjunction with FIGS. 1 and 2.

With reference to FIG. 3A, the user 102, who is traversing the route (shown in FIG. 2) in the transport vehicle 106, may utilize the user device 104 to access the service application 118 (as shown by arrow 302). The service application 118 may render the UI on the display of the user device 104 (as shown by arrow 304). Through the UI, the service application 118 may prompt the user 102 to provide the route information of the route that is being traversed by the user 102 in the transport vehicle 106 (as shown by arrow 306). Based on the prompt, the user 102 may provide the route information of the route (as shown by arrow 308). In another embodiment, the service application 118 may automatically obtain the route information of the route from the navigation application, running on the user device 104, used by the user 102 for navigating along the route. In one embodiment, the route information of the route may include, but is not limited to, the source location 202a and the destination location 202b of the route. In one embodiment, the service application 118 may automatically detect a current location (i.e., geographical location) of the user device 104 (as shown by arrow 310). For example, the current location of the user device 104 may be detected by way of the GPS or a navigation application running on the user device 104. The user device 104 may be a personal device carried by the user 102 while travelling in the transport vehicle 106 or a vehicle device placed in the transport vehicle 106. Therefore, the current location of the user device 104 corresponds to the current location of the transport vehicle 106. In another embodiment, the service application 118 may prompt the user 102 to manually enter the current location. In such a scenario, the user 102 may manually enter the current location in the service application 118. In a non-limiting example, it is assumed that the current location of the transport vehicle 106 is the source location 202a.

The user device 104 may communicate, to the application server 108, the route information and the current location of the transport vehicle 106 (as shown by arrow 312). Based on the received route information and the received current location, the application server 108 may identify a set of products available for purchase by the user 102 and the set of pickup locations 204 along the route for collecting the set of products (as shown by arrow 314). The set of pickup locations 204 may correspond to intermediate locations on the route, between the source location 202a and the destination location 202b. In a non-limiting example, each of the set of pickup locations 204 may correspond to a toll collection station (i.e., a toll station or a toll booth). As described in the foregoing description of FIG. 2, the set of pickup locations 204 includes three pickup locations, i.e., the first through third pickup locations 204a-204c. The set of products may include various products that are offered for sale by various merchants that are associated with the entity maintaining the application server 108.

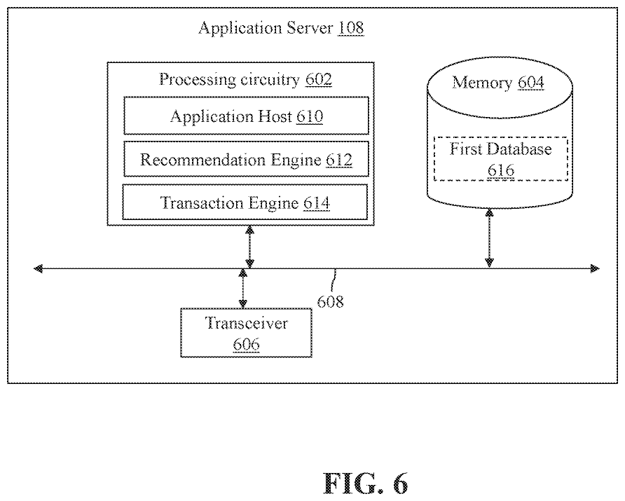

In one exemplary scenario, the application server 108 may identify first through third sets of products and the set of pickup locations 204 based on a first database stored in a memory (shown in FIG. 6) of the application server 108. The first database may be indicative of various merchants that are capable of delivering or facilitating delivery of a corresponding set of products to at least one of the set of pickup locations 204. For example, based on the route information, the current location, and information stored in the first database, the application server 108 may identify those merchants (e.g., first through third merchants) that have stores, warehouses, and/or delivery centers in proximity (i.e., within delivery range) to at least one of the set of pickup locations 204. Following the identification of the first through third merchants, the application server 108 may extract a list of products offered for sale by the first through third merchants. In a non-limiting example, the list may include first through third sets of products. In another exemplary scenario, the application server 108 may determine that only the first merchant has an option to deliver along the route being traversed by the user 102 (i.e., the second and third merchants do not currently deliver to any of the set of pickup locations 204). Consequently, the application server 108 may filter out the second and third sets of products to identify only the first set of products.

Upon identification of the first set of products and the set of pickup locations 204, the application server 108 may communicate the first set of products and the set of pickup locations 204 to the user device 104 for recommending to the user 102 (as shown by arrow 316). In other words, the application server 108 may recommend the list of products to the user device 104 for purchase.

Referring now to FIG. 3B, the service application 118 may present, through the UI, the first set of products available for purchase (as shown by arrow 318). The user 102 may select one or more products from the first set of products for purchase (as shown by arrow 320). For example, the user 102 selects the first product from the first set of products for purchase. Consequently, the service application 118 may present the set of pickup locations 204, through the UI, prompting the user 102 to select a pickup location for collecting the selected first product (as shown by arrow 322). The user 102 may select the first pickup location 204a for collecting the first product (as shown by arrow 324).

Upon selection of the first pickup location 204a, the service application 118 may prompt the user 102 to enter a pickup time for collecting the first product at the first pickup location (as shown by arrow 326). The user 102 may enter the pickup time based on an expected time of arrival at the first pickup location 204a (as shown by arrow 328). In another embodiment, the service application 118 may automatically detect the pickup time based on the navigation application or program that runs on the user device 104. For example, a location of the user device 104 may be monitored to determine an expected time of arrival of the transport vehicle 106 at the first pickup location 204a. The determination of the pickup time may be based on various factors such as, but not limited to, traffic data pertaining to traffic along the route, current or predicted weather conditions along the route, or the like.

The service application 118 may present to the user 102, on the UI, a transaction amount for the purchase of the first product. In the current embodiment, the transaction amount may be equal to a price of the first product. In another embodiment, the transaction amount may include charges (e.g., packaging charges, delivery charges, or the like), in addition to the price of the first product. The service application 118 may present a set of payment modes and prompt the user 102 to select a payment mode for paying the transaction amount (as shown by arrow 330). The set of payment modes may include, but are not limited to, a transaction card (e.g., a debit card or a credit card), netbanking, digital wallets, the RF tag 120, or the like.

Referring now to FIG. 3C, from the displayed set of payment modes, the user 102 selects to pay using the RF tag 120 (as shown by arrow 332). Consequently, the user device 104 may communicate an identifier request to the first RF reader 122 for acquiring the identifier of the RF tag 120 (as shown by arrow 334). The identifier request may activate the first RF reader 122 for reading the identifier of the RF tag 120. Based on the identifier request, the first RF reader 122 may communicate a first query request to the RF tag 120 for acquiring the identifier of the RF tag 120 (as shown by arrow 336). The first query request may activate the RF tag 120. On activation, the RF tag 120 may communicate a first query response to the first RF reader 122 (as shown by arrow 338). The first query response may be indicative of the identifier of the RF tag 120. The first RF reader 122 may communicate an identifier response, indicative of the identifier of the RF tag 120, to the user device 104 (as shown by arrow 340). In another embodiment, the user 102 may manually input the identifier of the RF tag 120 to the user device 104. In another embodiment, the first RF reader 122 may be a part of the user device 104.

Referring now to FIG. 3D, the user device 104 may then communicate the order request to the application server 108 for the purchase of the selected first product (as shown by arrow 342). The order request may be indicative of the first product selected by the user 102 for purchase, the first pickup location 204a for collecting the first product, the pickup time, and the identifier of the RF tag 120. Based on the first product selected by the user 102, the application server 108 may communicate a delivery request to the merchant server 110 (as shown by arrow 344). The delivery request may be indicative of the first product, the first pickup location 204a, and the pickup time. The delivery request may constitute a request to the first merchant to deliver or to facilitate the delivery of the first product to the first pickup location 204a by the pickup time. The first merchant may accept or decline the delivery request. Based on whether the first merchant accepts or declines the delivery request, the merchant server 110 may communicate a delivery response to the application server 108. In a non-limiting example, the first merchant accepts the delivery request (as shown by arrow 346). Consequently, the merchant server 110 communicates the delivery response indicative of the acceptance of the delivery request to the application server 108 (as shown by arrow 348). The order request is accepted by the application server 108 when the delivery response indicates acceptance of the delivery request by the first merchant. The first merchant may facilitate delivery of the first product to the first pickup location 204a (i.e., the first toll collection station) prior to the pickup time. Following the delivery of the first product to the first pickup location 204a, the merchant server 110 may communicate a first notification to the application server 108, indicating a successful delivery of the first product to the first pickup location 204a (as shown by arrow 350). The first notification may further indicate of a time of delivery of the first product to the first pickup location 204a.

Referring now to FIG. 3E, based on the delivery response, the application server 108 may communicate, to the toll server 112, a first message indicative of the first product and the identifier of the RF tag 120 (as shown by arrow 352). The first message is communicated to the toll server 112 for identification of the transport vehicle 106 and facilitating the collection of the first product by the user 102. The first message may further include one or more details (e.g., the pickup time, or the like) of the order request. Based on the delivery response, the application server 108 may attempt to pre-authorize the purchase of the first product by the user 102. The application server 108 may identify the issuer that corresponds to the identifier of the RF tag 120 by referring to the first database. The application server 108 may initiate a blocking of the transaction amount from the first payment account of the user 102 by communicating a first blocking request to the issuer server 114 of the identified issuer (as shown by arrow 354). The first blocking request may be indicative of the identifier of the RF tag 120, an identifier of the first merchant, and the transaction amount. Based on the first blocking request, the issuer server 114 may block the transaction amount from the first payment account (as shown by arrow 356). In one embodiment, the blocked transaction amount may remain in the first payment account, but may not be accessible to the user 102. Upon blocking of the transaction amount, the issuer server 114 may communicate a first blocking response to the application server 108 (as shown by arrow 358). The first blocking response may indicate that the transaction amount is successfully blocked. The purchase of the first product by the user 102 is now pre-authorized.

Referring now to FIG. 3F, the second RF reader 124 may send query requests to those transport vehicles that are in proximity (i.e., within communication range) to the second RF reader 124 or the first pickup location 204a. When the transport vehicle 106 is within the communication range of the second RF reader 124, the second RF reader 124 may communicate a second query request to the RF tag 120 for acquiring the identifier of the RF tag 120 (as shown by arrow 360). The second query request may activate the RF tag 120. On activation, the RF tag 120 may communicate a second query response to the second RF reader 124 (as shown by arrow 362). The second query response may be indicative of the identifier of the RF tag 120. The second RF reader 124 may communicate a second notification to the toll server 112, indicating that the second RF reader 124 has detected the transport vehicle 106 having the RF tag 120 at the first pickup location 204a (as shown by arrow 364). The second notification may include the identifier of the RF tag 120.

Referring now to FIG. 3G, the toll server 112 may communicate the second notification to the application server 108 (as shown by arrow 366). Based the first message and the second notification, the toll server 112 may determine that the first product is to be collected by the user 102 in the transport vehicle 106 (as shown by arrow 368). The first product may be collected by the user 102 at the first pickup location 204a. Upon collection of the first product, the toll server 112 may communicate a third notification indicative of the collection of the first product by the user 102 to the application server 108 (as shown by arrow 370). The third notification may be further indicative of a toll fee amount to be paid by the user 102 for transiting through the first toll collection station (i.e., the first pickup location 204a). Based on the third notification, the application server 108 may initiate deduction of the transaction amount and the toll fee amount from the first payment account. For initiating the deduction of the transaction amount and the toll fee amount from the first payment account, the application server 108 may communicate a first deduction request to the issuer server 114 (as shown by arrow 372).

Based on the first deduction request, the issuer server 114 may deduct the blocked transaction amount and the toll fee amount from the first payment account (as shown by arrow 374). Upon deduction of the transaction amount and the toll fee amount, the issuer server 114 may communicate a first deduction response, indicative of the deduction of the transaction amount and the toll fee amount, to the application server 108 (as shown by arrow 376). The application server 108 may initiate a transfer of the transaction amount and the toll fee amount to the second and third payment accounts by communicating a first transfer request to the issuer server 114 (as shown by arrow 378). The first transfer request may be indicative of the second and third payment accounts. Consequently, the issuer server 114 may transfer the deducted transaction amount and the deducted toll fee amount to the second and third payment accounts, respectively (as shown by arrow 380). Consequently, the issuer server 114 may communicate a first transfer response to the application server 108, indicating that the transaction amount and the toll fee amount have been transferred to the second and third payment accounts, respectively (as shown by arrow 382). The issuer server 114 may further communicate a notification to the user device 104, apprising the user 102 of the deduction of the toll fee amount and the transaction amount from the first payment account.

In another embodiment, the set of pickup locations 204 may not include any RF readers. As a result, the first pickup location 204a may not include the second RF reader 124. In such scenarios, the user device 104 may communicate a notification to the application server 108 when the service application 118 detects that a current location of the user device 104 (i.e., location of the transport vehicle 106) corresponds to the first pickup location 204a. The user device 104 may communicate another notification when the user 102 confirms, by way of the service application 118, the collection of the first product from the first pickup location 204a. The application server 108 may communicate the first deduction request to the issuer server 114 following the reception of the other notification.

In another embodiment, a balance in the first payment account may not be sufficient to pay for the purchase of the first product. In other words, the balance is less than the transaction amount. In such a scenario, the issuer server 114 may notify the application server 108 regarding insufficient balance in the first payment account when the issuer server 114 attempts to block the transaction amount. Consequently, the application server 108 may communicate a cancellation request to the merchant server 110, requesting the first merchant to cancel the delivery of the first product. The application server 108 may further notify the user 102 about insufficient balance in the first payment account and the cancellation of the delivery of the first product (i.e., cancellation of the order request).

In another embodiment, the user 102 may not reach or halt at the first pickup location 204a for collecting the first product. In such a scenario, the application server 108 may levy a penalty (i.e., a part of the blocked transaction) at a time-instance after the pickup time to mitigate financial losses to the first merchant. The amount of penalty may be decided by the first merchant. Further, the application server 108 may have informed the user 102 regarding the penalty amount when the user 102 had initiated the order request for the purchase. The toll fee amount may be deducted from the first payment account depending on whether the toll fee amount is applicable to the transport vehicle 106.

In another embodiment, the application server 108 may be operated by a ride service provider and the service application 118 may be a ride-booking application. In such a scenario, the application server 108, along with providing ride booking services to the user 102, facilitates in-transit purchases of products from one or more affiliated merchants. In such a scenario, the transport vehicle 106 is a rented vehicle and a payment account linked to the RF tag 120 corresponds to the ride service provider. Thus, the transaction amount and the toll fee amount may be deducted from the payment account of the ride service provider for transfer to the second and third payment accounts and a sum of ride fare, the transaction amount, and the toll fee amount may be deducted from the first payment account of the user 102 for transfer to the payment account of the ride service provider.

FIGS. 4A-4G, collectively represent a process flow diagram 400 that illustrates facilitation of in-transit purchase of products by the application server 108, in accordance with another exemplary embodiment of the present disclosure. The process flow diagram 400 involves the user device 104, the transport vehicle 106, the application server 108, the toll server 112, and the issuer server 114. The process flow diagram 400 further involves the RF tag 120, the first RF reader 122, and the second RF reader 124. FIGS. 4A-4G are explained in conjunction with FIGS. 1 and 2. FIGS. 4A-4G describe a scenario where the application server 108 is operated by a single merchant (i.e., the first merchant). The application server 108, in such a scenario, may perform functions of the merchant server 110 and may facilitate in-transit purchase of products that are offered for sale by the first merchant. In other words, the application server 108 may be the merchant server 110.

With reference to FIG. 4A, the user 102, who is traversing the route (shown in FIG. 2) in the transport vehicle 106, may utilize the user device 104 to access the service application 118 (as shown by arrow 402). The service application 118 may render the UI on the display of the user device 104 (as shown by arrow 404). Through the UI, the service application 118 may prompt the user 102 to provide the route information of the route that is being traversed by the user 102 in the transport vehicle 106 (as shown by arrow 406). Based on the prompt, the user 102 may provide the route information of the route (as shown by arrow 408). The service application 118 may detect a current location (i.e., geographical location) of the user device 104 by way of the GPS or the navigation application running on the user device 104 (as shown by arrow 410). The user device 104 may be the personal device of the user 102 or the vehicle device placed in the transport vehicle 106. Therefore, the current location of the user device 104 may correspond to a current location of the transport vehicle 106. In a non-limiting example, it is assumed that the current location of the transport vehicle 106 is the source location 202a.

The user device 104 may communicate, to the application server 108, the route information and the current location of the transport vehicle 106 (as shown by arrow 412). Based on the received route information and the received current location, the application server 108 may identify a set of products available for purchase by the user 102 and the set of pickup locations 204 along the route for collecting the set of products (as shown by arrow 414). The set of pickup locations 204 may correspond to intermediate locations on the route, between the source location 202a and the destination location 202b. In a non-limiting example, each of the set of pickup locations 204 may correspond to a toll collection station. The set of products may include only products offered for sale by the first merchant. In other words, the set of products may include only the first set of products. The application server 108 may communicate the set of products and the set of pickup locations 204 to the user device 104 for recommending to the user 102 (as shown by arrow 416).

Referring now to FIG. 4B, the service application 118 may present, on the UI, the first set of products available for purchase (as shown by arrow 418). The user 102 may select one or more products from the first set of products for purchase. In a non-limiting example, the user 102 may select the first product for purchase (as shown by arrow 420). Consequently, the service application 118 may present the set of pickup locations 204 along the route, prompting the user 102 to select a pickup location for collecting the selected first product (as shown by arrow 422). The user 102 may select the first pickup location 204a for collecting the first product (as shown by arrow 424). Upon selection of the first pickup location 204a, the service application 118 may prompt the user 102 to enter a pickup time for collecting the first product at the first pickup location 204a (as shown by arrow 426).

The user 102 may enter the pickup time based on an expected time of arrival at the first pickup location 204a (as shown by arrow 428). In another embodiment, the service application 118 may automatically detect the pickup time based on the navigation application or program that runs on the user device 104. The service application 118 may present to the user, on the UI, the transaction amount for the purchase of the first product. The service application 118 may present a set of payment modes and prompt the user 102 to select a payment mode for paying the transaction amount (as shown by arrow 430). The set of payment modes may include, but are not limited to, a transaction card (e.g., a debit card or a credit card), netbanking, digital wallets, the RF tag 120, or the like.

Referring now to FIG. 4C, from the displayed set of payment modes, the user 102 selects to pay using the RF tag 120 (as shown by arrow 432). Consequently, the user device 104 may communicate an identifier request to the first RF reader 122 for acquiring the identifier of the RF tag 120 (as shown by arrow 434). The identifier request may activate the first RF reader 122. Based on the identifier request, the first RF reader 122 may communicate a third query request to the RF tag 120 for acquiring the identifier of the RF tag 120 (as shown by arrow 436). The third query request may activate the RF tag 120. On activation, the RF tag 120 may communicate a third query response to the first RF reader 122 (as shown by arrow 438). The third query response may be indicative of the identifier of the RF tag 120. The first RF reader 122 may communicate an identifier response, indicative of the identifier of the RF tag 120, to the user device 104 (as shown by arrow 440). In another embodiment, the user 102 may manually input the identifier of the RF tag 120 to the user device 104.

Referring now to FIG. 4D, the user device 104 may communicate the order request to the application server 108 for the purchase of the selected first product (as shown by arrow 442). The order request may be indicative of the first product selected by the user 102 for purchase, the first pickup location 204a, the pickup time, and the identifier of the RF tag 120. The application server 108 may accept the order request (as shown by arrow 444). The first merchant may facilitate delivery of the first product to the first pickup location 204a (i.e., the first toll collection station) by the pickup time.

Based on the acceptance of the order request, the application server 108 may communicate, to the toll server 112, a second message indicative of the first product and the identifier of the RF tag 120 (as shown by arrow 446). The second message may be communicated to the toll server 112 for identification of the transport vehicle 106 and for facilitating the collection of the first product by the user 102. The second message may further include one or more details (e.g., the pickup time, or the like) of the order request. The application server 108 may attempt to pre-authorize the purchase of the first product by the user 102. The application server 108 may identify the issuer that corresponds to the identifier of the RF tag 120 by referring to the first database.

Referring now to FIG. 4E, based on the delivery response, the application server 108 may initiate a blocking of the transaction amount from the first payment account of the user 102 by communicating a second blocking request to the issuer server 114 (as shown by arrow 448). The second blocking request may be indicative of the identifier of the RF tag 120, an identifier of the first merchant, and the transaction amount. The application server 108 may block the transaction amount from the first payment account (as shown by arrow 450). Upon blocking the transaction amount, the issuer server 114 may communicate a second blocking response to the application server 108 (as shown by arrow 452). The second blocking response may indicate that the transaction amount is blocked. The blocking of the transaction amount for the purchase of the first product may constitute pre-authorization of the purchase of the first product.

Now referring to FIG. 4F, the second RF reader 124 may send query requests to transport vehicles that are in proximity (i.e., within communication range) to the second RF reader 124 or the first pickup location 204a. When the transport vehicle 106 is in communication range of the second RF reader 124, the second RF reader 124 may communicate a fourth query request to the RF tag 120 for acquiring the identifier of the RF tag 120 (as shown by arrow 454). The fourth query request may activate the RF tag 120. On activation, the RF tag 120 may communicate a fourth query response to the second RF reader 124 (as shown by arrow 456). The fourth query response may be indicative of the identifier of the RF tag 120. The second RF reader 124 may communicate a fourth notification to the toll server 112, indicating that the second RF reader 124 has detected the transport vehicle 106 having the RF tag 120 at the first pickup location 204a (as shown by arrow 458). The fourth notification may include the identifier of the RF tag 120.

Referring now to FIG. 4G, the toll server 112 may communicate the fourth notification to the application server 108 (as shown by arrow 460). Based the second message and the fourth notification, the toll server 112 may determine that the first product is to be collected by the user 102 in the transport vehicle 106 (as shown by arrow 462). The first product may be collected by the user 102 at the first pickup location 204a. Upon collection of the first product, the toll server 112 may communicate a fifth notification to the application server 108, indicating the collection of the first product by the user 102 (as shown by arrow 464). Based on the fifth notification, the application server 108 may communicate a second deduction request to the issuer server 114 for initiating the deduction of the transaction amount and the toll fee amount from the first payment account (as shown by arrow 466). Based on the second deduction request, the issuer server 114 may deduct the blocked transaction amount and the toll fee amount from the first payment account (as shown by arrow 468). Following the deduction, the issuer server 114 may communicate a second deduction response to the application server 108 (as shown by arrow 470). The second deduction response may be indicative of the deduction of the transaction amount and the toll fee amount from the first payment account. The application server 108 may initiate a transfer of the transaction amount and the toll fee amount to the second and third payment accounts by communicating a second transfer request to the issuer server 114 (as shown by arrow 472). The second transfer request may be indicative of the second and third payment accounts. The issuer server 114 may transfer the transaction amount and the toll fee amount to the second and third payment accounts, respectively (as shown by arrow 474). Consequently, the issuer server 114 may communicate a second transfer response to the application server 108, indicating that the transaction amount and the toll fee amount have been transferred to the second and third payment accounts, respectively (as shown by arrow 476).

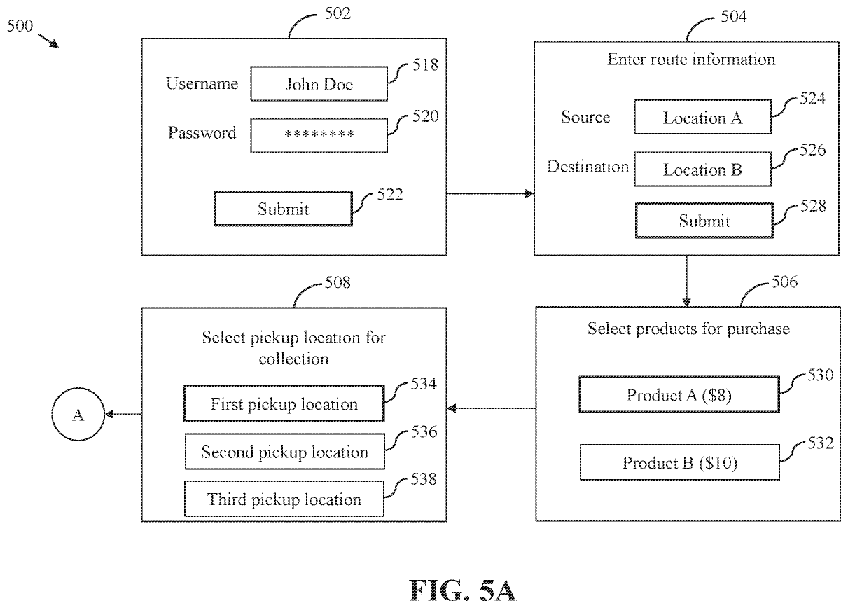

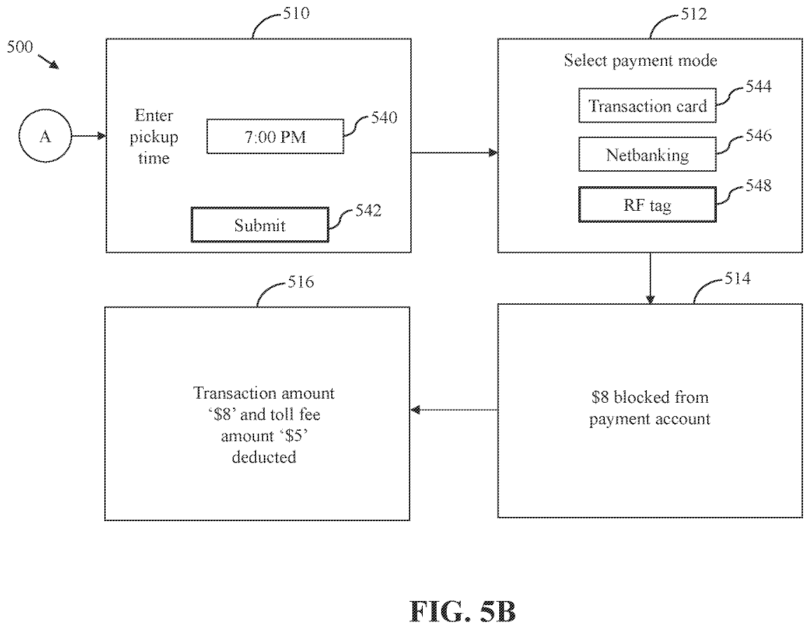

FIGS. 5A and 5B, collectively represent an exemplary scenario 500 that illustrates UI screens 502-516 rendered on the user device 104 for facilitating in-transit purchase of products, in accordance with an exemplary embodiment of the present disclosure. FIGS. 5A and 5B are explained in conjunction with FIGS. 3A-3G. The UI screens 502-516 are displayed on the display of the user device 104 by the service application 118.

When the user 102 accesses the service application 118, the service application 118 may render the UI screen 502. The UI screen 502 may request the user 102 to enter a username and a password to log into the service application 118. The user 102 may enter the username and the password in first and second text boxes 518 and 520, respectively. After entering the username and the password, the user 102 may select a first submit button 522 for logging into the service application 118. The user device 104 may communicate an authentication request to the application server 108 for authentication of the user 102. The authentication request may include the entered username and password. The application server 108 may authenticate the user 102 and communicate an authentication response to the user device 104. If the authentication response is indicative of successful authentication of the user 102, control is redirected to the UI screen 504.

The UI screen 504 may prompt the user 102 to provide the route information (i.e., the source and destination locations 202a and 202b) for the route that is to be traversed or is being traversed by the user 102. The user 102 enters the source and destination locations 202a and 202b of the route in third and fourth textboxes 524 and 526, respectively. In the current embodiment, the source location 202a may correspond to the current location of the user device 104 or the transport vehicle 106. Therefore, the source location 202a (i.e., ‘Location A’) may be automatically detected by the user device 104. In such a scenario, the user 102 may only enter the destination location 202b of the route (i.e., ‘Location B’). On entering the source and destination locations 202a and 202b of the route, the user 102 may select the second submit button 528. Upon selection of the second submit button 528, the user device 104 communicates the route information and the current location to the application server 108. Control is then redirected to UI screen 506.

The UI screen 506 may present the set of products available for purchase. For the sake of brevity, only two products, i.e., the first product (e.g., Product A) and a second product (e.g., Product B) are shown. It will be apparent to those of skill in the art that the UI screen 506 may present any number of products for purchase without deviating from the scope of the disclosure. The UI screen 506 may further present first (e.g., ‘$8’) and second prices (e.g., ‘$10’) of the first and second products, respectively. The user 102 may select the first product and/or the second product for purchase by selecting a first user-selectable option 530 and/or a second user-selectable option 532, respectively. In one example, the user 102 may select the first user-selectable option 530 for selecting the first product for purchase. Control is then directed to UI screen 508.

The UI screen 508 prompts the user 102 to select a pickup location from the set of pickup locations 204 for collecting the first product. The user 102 may select one of the first through third pickup locations 204a-204c by selecting one of third through fifth user-selectable options 534, 536, and 538, respectively. To select the first pickup location 204a for collecting the first product, the user 102 selects the third user-selectable option 534. Control is then directed to UI screen 510.

UI screen 510 may present a message, prompting the user 102 to enter the pickup time for collecting the first product. The user 102 may enter the pickup time (e.g., ‘7:00 pm’) in a third text box 540. The user 102 may select a third submit button 542 after entering the pickup time. Control is then redirected to UI screen 512. UI screen 512 may present a message, prompting the user 102 to select a payment mode to pay the transaction amount (i.e., ‘$8’). In a non-limiting example, the user 102 may be allowed to pay the transaction amount by way of a transaction card (e.g., a debit card or a credit card), netbanking, or by way of the RF tag 120 (i.e., the first payment account associated with the RF tag 120). The UI screen 510 may present sixth through ninth user-selectable options 544, 546, and 548 for selecting the transaction card, netbanking, or the RF tag 120, respectively. As shown in FIG. 5C, the user 102 selects the ninth user-selectable option 548 to pay for the purchase of the first product using the RF tag 120. The user device 104 may communicate the order request to the application server 108. The transaction amount may be blocked from the first payment account that is linked to the RF tag 120 as described in the foregoing description of FIGS. 3A-3G. Control is then redirected to UI screen 514, which presents a message to the user indicating that the transaction amount is blocked from the first payment account. Based on the first deduction response, control is redirected to UI screen 516. The UI screen 516 may present a message, indicating that the transaction amount and the toll fee amount have been deducted from the first payment account when the user 102 reaches the first pickup location 204a in the transport vehicle 106 and collects the first product.

FIG. 6 is a block diagram that illustrates the application server 108, in accordance with an exemplary embodiment of the present disclosure. The application server 108 may include processing circuitry 602, the memory (hereinafter, referred to as ‘the memory 604’) of the application server 108, and a transceiver 606. The processing circuitry 602, the memory 604, and the transceiver 606 may communicate with each other by way of a communication bus 608. The processing circuitry 602 may include an application host 610, a recommendation engine 612, and a transaction engine 614.

The processing circuitry 602 may include suitable logic, circuitry, interfaces, and/or code, executed by the circuitry, to facilitate in-transit purchase of products. The processing circuitry 602 may be configured to receive the route information and the current location, identify the set of products and the set of pickup locations 204, and initiate blocking and deduction of the transaction amount. Examples of the processing circuitry 602 may include, but are not limited to, an application-specific integrated circuit (ASIC) processor, a reduced instruction set computer (RISC) processor, a complex instruction set computer (CISC) processor, a field programmable gate array (FPGA), and the like. The processing circuitry 602 may execute various operations for facilitating in-transit purchases of products (e.g., the first product) by way of the application host 610, the recommendation engine 612, and the transaction engine 614.

The memory 604 may include suitable logic, circuitry, interfaces, and/or code, executable by the circuitry, to store the first database (hereinafter, referred to and designated as “the first database 616”), information pertaining to transaction history (historical data regarding purchased products) of each user (e.g., the user 102), or the like. As described in the foregoing description of FIGS. 3A-3G, the first database 616 may store product information of various partner merchants. Thus, the first database 616 may indicate various merchants that are capable of delivering or facilitating delivery of a corresponding set of products to at least one of the set of pickup locations 204. Examples of the memory 604 may include a random-access memory (RAM), a read-only memory (ROM), a removable storage drive, a hard disk drive (HDD), a flash memory, a solid-state memory, and the like. It will be apparent to a person skilled in the art that the scope of the disclosure is not limited to realizing the memory 604 in the application server 108, as described herein. In another embodiment, the memory 604 may be realized in form of a database server or a cloud storage working in conjunction with the application server 108, without departing from the scope of the disclosure.

The application host 610 may host the service application 118 that facilitates in-transit purchase of products (e.g., the first product). The application host 610 may receive, from the user device 104, the route information and the current location of the user device 104. The application host 610 may communicate, to the user device 104, the identified set of products for purchase and the set of pickup locations 204 for collecting the set of products. The application host 610 may further receive, from the user device 104 by way of the service application 118, the order request initiated by the user 102.

The recommendation engine 612 may identify the set of products and the set of pickup locations 204 to be recommended to the user 102. The recommendation engine 612 may identify the set of products and the set of pickup locations 204 based on the received route information, the current location of the transport vehicle 106, and the information pertaining to the one or more merchants in the first database 616.

The transaction engine 614 may communicate with the issuer server 114 to initiate the blocking and the deduction of the transaction amount and/or the toll fee amount. Further, the transaction engine 614 may communicate with the merchant server 110 and the issuer server 114 for the pre-authorization of the purchase of the first product. Following the collection of the first product by the user 102, the transaction engine 614 may communicate with the issuer server 114 for initiating the deduction of the blocked transaction amount and the toll fee amount. The transaction engine 614 may further communicate with the issuer server 114 for initiating the transfer of the transaction amount and the toll fee amount to the second and third payment accounts, respectively.

The transceiver 606 may include suitable logic, circuitry, interfaces, and/or code, executable by the circuitry, to transmit and receive data over the communication network 116 using one or more communication network protocols. The transceiver 606 may transmit requests and messages to and receive requests and messages from the user device 104, the merchant server 110, the toll server 112, and the issuer server 114. Examples of the transceiver 606 may include, but are not limited to, an antenna, a radio frequency transceiver, a wireless transceiver, a Bluetooth transceiver, an ethernet port, a universal serial bus (USB) port, or any other device configured to transmit and receive data.

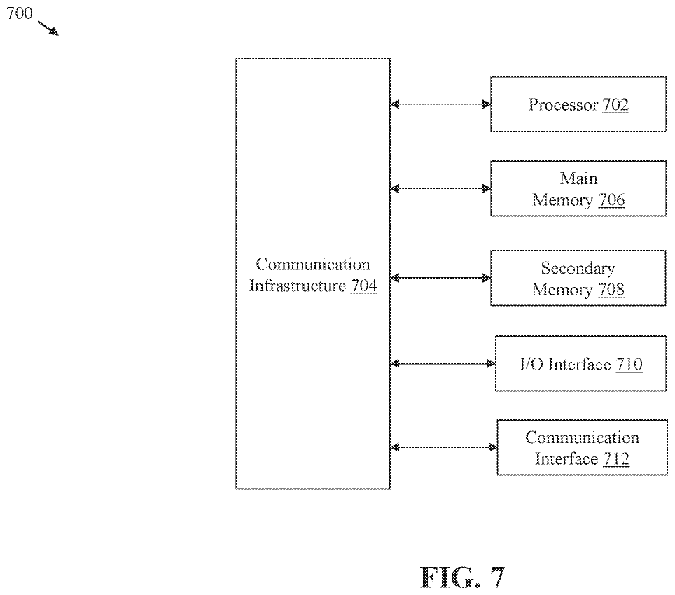

FIG. 7 is a block diagram that illustrates a system architecture of a computer system 700, in accordance with an exemplary embodiment of the present disclosure. An embodiment of disclosure, or portions thereof, may be implemented as computer readable code on the computer system 700. In one example, the user device 104, the application server 108, the merchant server 110, the toll server 112, and the issuer server 114 may be implemented as the computer system 700.

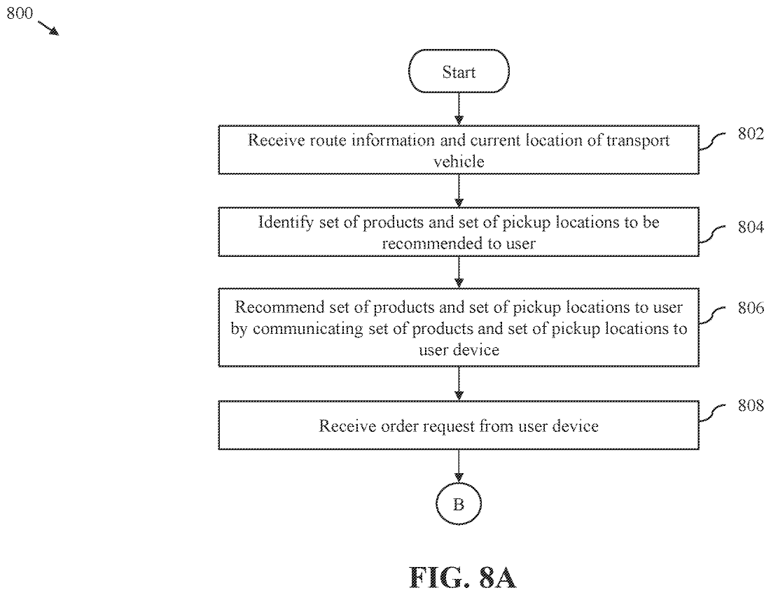

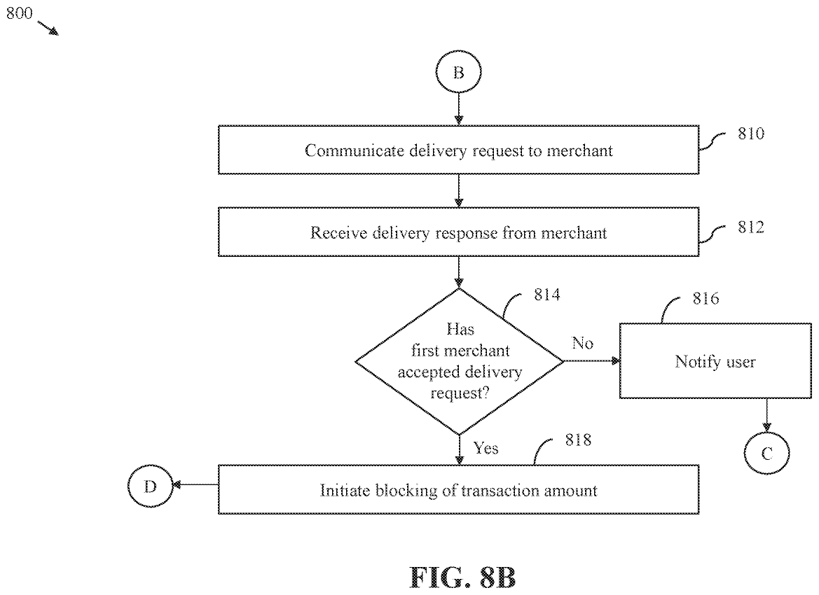

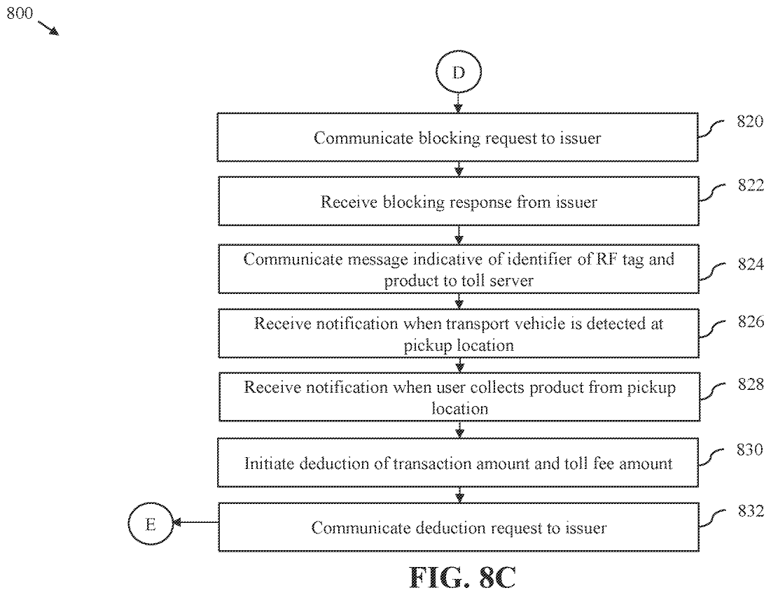

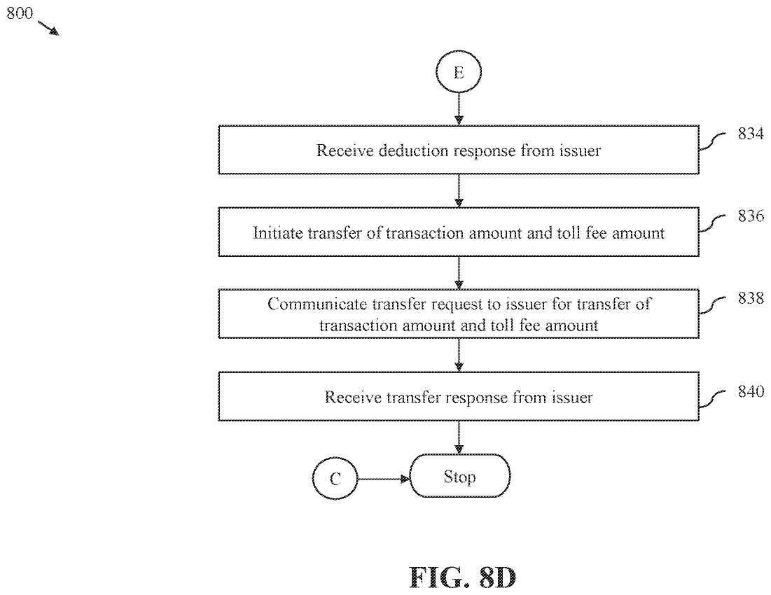

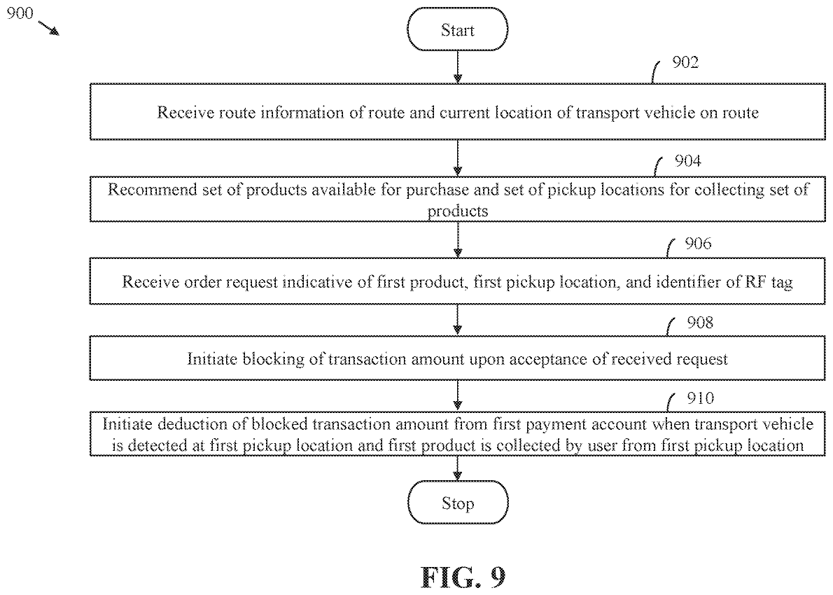

Hardware, software, or any combination thereof may embody modules and components used to implement methods of FIGS. 8A-8D and 9. The computer system 700 includes a processor 702 that may be a special-purpose or a general-purpose processing device. The processor 702 may be a single processor, multiple processors, or combinations thereof. Further, the processor 702 may be connected to a communication infrastructure 704, such as a bus, message queue, multi-core message-passing scheme, and the like. The computer system 700 may further include a main memory 706 and a secondary memory 708. Examples of the main memory 706 may include a RAM, a ROM, and the like. The secondary memory 708 may include an HDD or a removable storage drive, such as a floppy disk drive, a magnetic tape drive, a compact disc, an optical disk drive, a flash memory, and the like.

The computer system 700 further includes an input/output (I/O) interface 710 and a communication interface 712. The I/O interface 710 includes various input and output devices that are configured to communicate with the processor 702. Examples of the input devices may include a keyboard, a mouse, a joystick, a touchscreen, a microphone, and the like. Examples of the output devices may include a display screen, a speaker, headphones, and the like. The communication interface 712 may be configured to allow data to be transferred between the computer system 700 and various devices that are communicatively coupled to the computer system 700. Examples of the communication interface 712 may include a modem, a network interface, i.e., an Ethernet card, a communication port, and the like. Data transferred via the communication interface 712 may correspond to signals, such as electronic, electromagnetic, optical, or other signals as will be apparent to a person skilled in the art.

FIGS. 8A-8D, collectively represent a flow chart 800 that illustrates a method for facilitating in-transit purchases of products, in accordance with an exemplary embodiment of the present disclosure.

With reference to FIG. 8A, at step 802, the application server 108 receives the route information and the current location of the transport vehicle 106. The process proceeds to step 804. At step 804, based on the received route information, the current location, and information stored in the memory 604, the application server 108 identifies the set of products and the set of pickup locations 204 to be recommended to the user 102. The process proceeds to step 806. At step 806, the application server 108 recommends the set of products and the set of pickup locations to the user 102 by communicating the set of products and the set of pickup locations 204 to the user device 104. The recommended set of products and the recommended set of pickup locations 204 are presented on the UI rendered on the display of the user device 104 (as shown in FIGS. 5A and 5B). The recommended set of products and the recommended set of pickup locations 204 are selectable by the user 102. The process proceeds to step 808. At step 808, the application server 108 receives the order request. The order request is indicative of a product (e.g., the first product) selected by the user 102 for purchase, a pickup location (e.g., the first pickup location 204a) along the route selected by the user 102 for collecting the first product, the pickup time, and the identifier of the RF tag 120. The process proceeds to step 810.

With reference to FIG. 8B, at step 810, based on the order request, the application server 108 communicates the delivery request to the merchant server 110. The process proceeds to step 812. At step 812, the application server 108 receives the delivery response from the merchant server 110. The process proceeds to step 814. At step 814, the application server 108 determines whether the first merchant has accepted the delivery request. If at step 814, the application server 108 determines that the first merchant has not accepted (i.e., declined) the delivery request, step 816 is performed. At step 816, the application server 108 notifies the user 102 by communicating a notification to the user device 104, indicating that the order request is declined and the process stops. If at step 814, the application server 108 determines that the first merchant has accepted the delivery request, step 818 is performed. At step 818, the application server 108 initiates a blocking of the transaction amount to indicate acceptance of the order request. The process proceeds to step 820.

With reference to FIG. 8C, at step 820, the application server 108 communicates a blocking request (e.g., the first blocking request) to the issuer server 114 for blocking the transaction amount. The issuer server 114 blocks the transaction amount from the first payment account based on the blocking request. The blocking of the transaction amount from the first payment account constitutes the pre-authorization of the purchase of the first product by the user 102. Following the blocking of the transaction amount, the issuer server 114 communicates a blocking response (e.g., the first blocking response) to the application server 108. The process proceeds to step 822. At step 822, the application server 108 receives the blocking response from the issuer server 114. The process proceeds to step 824.

At step 824, the application server 108 communicates to the toll server 112 (corresponding to the first pickup location 204a selected by the user 102) a message (e.g., the first message) indicative of the first product and the identifier of the RF tag 120. The second RF reader 124 detects the transport vehicle 106 when the transport vehicle 106 is at the first pickup location 204a. The second RF reader 124 notifies the toll server 112 of the detection of the transport vehicle 106. The process proceeds to step 826. At step 826, the application server 108 receives a notification (e.g., the second notification) from the toll server 112. The notification is indicative of the detection of the transport vehicle 106 at the first pickup location 204a. The process proceeds to step 828. At step 828, the application server 108 receives another notification (e.g., the third notification) from the toll server 112. The notification is indicative of the collection of the first product by the user 102. The process proceeds to step 830. At step 830, the application server 108 initiates a deduction of the transaction amount and the toll fee amount from the first payment account of the user 102. The process proceeds to step 832. At step 832, the application server 108 communicates a deduction request (e.g., the first deduction request) to the issuer server 114 for deducting the transaction amount and the toll fee amount from the first payment account. As described in the foregoing, the issuer server 114 deducts the transaction amount and the toll fee amount from the first payment account. The process proceeds to step 834.

With reference to FIG. 8D, at step 834, the application server 108 receives a deduction response (e.g., the first deduction response) from the issuer server 114. The deduction response indicates the deduction of the transaction amount and the toll fee amount from the first payment account. The process proceeds to step 836. At step 836, the application server 108 initiates a transfer of the transaction amount and the toll fee amount to the second and the third payment accounts, respectively. The process proceeds to step 838. At step 838, the application server 108 communicates a transfer request (e.g., the first transfer request) to the issuer server 114 for transferring the transaction amount and the toll fee amount to second and third payment accounts, respectively. The issuer server 114 transfers the transaction amount and the toll fee amount to the second and third payment accounts, respectively, based on the received transfer request. Upon transfer, the issuer server 114 may communicate a transfer response (e.g., the first transfer response), indicating the transfer of the transaction amount and toll fee amount to the second and third payment accounts, respectively. The process proceeds to step 840. At step 840, the application server 108 receives the transfer response from the issuer server 114 and the process stops.

FIG. 9 represents a high-level flow chart 900 that illustrates a method for facilitating in-transit purchase of products, in accordance with an exemplary embodiment of the present disclosure. At step 902, the application server 108 receives route information of a route being traversed by the user 102 in the transport vehicle 106 and the current location of the transport vehicle 106 on the route. Based on the received route information and the current location, the application server 108 identifies a set of products that are available for purchase and a set of pickup locations along the route for collecting the set of products. The application server 108 communicates the set of pickup locations and the set of products to the user device 104. At step 904, the application server 108 recommends, to the user 102 by way of the user device 104, the set of products available for purchase and the set of pickup locations for collecting the set of products. An order request may be initiated by the user 102 by way of the service application 118. The user device 104 communicates the order request to the application server 108. At step 906, the application server 108 receives the order request from the user device 104. The order request is indicative of the first product selected by the user 102 from the set of products for purchase and the first pickup location selected by the user 102 from the set of pickup locations 204 for collecting the first product. The order request is further indicative of the identifier of the RF tag 120 placed in the transport vehicle 106. At step 908, the application server 108, upon acceptance of the order request, initiates a blocking of the transaction amount associated with the first product from the first payment account that is linked to the identifier. The transaction amount may be blocked from the first payment account. At step 910, the application server 108 initiates a deduction of the blocked transaction amount from the first payment account when the transport vehicle 106 is detected at the first pickup location 204a and the first product is already delivered to the first pickup location 204a. The delivered first product is then collected from the first pickup location 204a by the user 102.

Thus, the environment 100 offers a convenient means for facilitating in-transit purchase of products. The application server 108 may be associated with various merchants (e.g., the first through third merchants) allowing the user 102, who is in-transit, to choose from a wide variety of products that are offered for sale. The application server 108 uses the route information and the current location of the transport vehicle 106 to identify merchants that are optimally suited to serve the user 102 along the route of travel. The disclosure leverages existing infrastructure (i.e., RF tags used for toll payments) for implementing the solution, thereby minimizing a cost of implementing embodiments described in the disclosure. Users may purchase products by way of the service application 118, increasing a convenience of purchasing products. The purchased products are delivered to pickup locations (e.g., the first pickup location) selected by the user 102. The pickup locations correspond to intermediate locations, such as toll collection stations, on the route being traversed by the user 102. Therefore, the user 102 is not required to deviate from the route to collect the purchased products. Any purchase or transaction initiated by the user 102 is pre-authorized by the application server 108, drastically minimizing likelihood of fraud and safeguarding the interests of merchants (e.g., the first merchant). The embodiments of the disclosure describe settlement of both the transaction amount and the toll fee amount using the RF tag 120 in the transport vehicle 106, providing a one stop solution for shopping as well as travelling. The embodiments of the disclosure reduce usage of cash for purchases, promote electronic payments, and enable seamless purchasing and collection of purchased products during travelling.

Techniques consistent with the present disclosure provide, among other features, systems and methods for facilitating in-transit purchase of products. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

We claim:

1. A method for facilitating in-transit purchase of products, the method comprising:
receiving, by an application server, from a user device of a user, route information of a route being traversed by the user in a transport vehicle and a current location of the transport vehicle on the route;
recommending, by the application server, to the user by way of the user device, a set of products available for purchase and a set of pickup locations on the route for collecting the set of products, wherein the set of products and the set of pickup locations are recommended based on the received route information and the received current location;
receiving, by the application server, an order request from the user device, wherein the order request is indicative of a first product selected by the user from the set of products for purchase, a first pickup location selected by the user from the set of pickup locations for collecting the first product, and an identifier of a radio frequency (RF) tag placed in the transport vehicle;
initiating, by the application server, upon acceptance of the received order request, blocking of a transaction amount associated with the first product from a first payment account that is linked to the identifier; and
initiating, by the application server, deduction of the blocked transaction amount from the first payment account when the transport vehicle is detected at the first pickup location and the first product is delivered to the first pickup location, wherein the first product is collected by the user from the first pickup location.

2. The method of claim 1, wherein the first pickup location is a toll collection station.

3. The method of claim 2, further comprising:
initiating, by the application server, a deduction of a toll fee amount from the first payment account, in addition to the blocked transaction amount; and
initiating, by the application server, a transfer of the deducted transaction amount and the deducted toll fee amount to a second payment account of a merchant associated with the first product and a third payment account of the toll collection station, respectively.

4. The method of claim 2, further comprising:
communicating, by the application server, to a toll server associated with the first pickup location, the identifier of the RF tag upon blocking of the transaction amount from the first payment account; and
receiving, by the application server, from the toll server, a notification when the transport vehicle is detected at the first pickup location by an RF reader at the first pickup location, wherein the transport vehicle is detected at the first pickup location by the RF reader based on the identifier communicated to the toll server.

5. The method of claim 1, further comprising receiving, by the application server, a notification from the user device when a location of the user device corresponds to the first pickup location, wherein the notification indicates the detection of the transport vehicle at the first pickup location.

6. The method of claim 1, further comprising:
communicating, by the application server, the received order request, to a merchant server of a merchant for delivering the first product to the first pickup location; and
receiving, by the application server, from the merchant server, a response indicating the acceptance of the order request by the merchant.

7. The method of claim 1, wherein when the first product is selected for purchase by the user by way of the user device, an RF reader placed in the transport vehicle is activated for reading the identifier of the RF tag, and wherein the identifier read by the RF reader is included in the order request.

8. The method of claim 1, further comprising hosting, by the application server, a service application that is executable on the user device, wherein the order request is initiated through the service application.

9. The method of claim 1, further comprising identifying, by the application server, based on the route information, the set of pickup locations on the route and the set of products that are available for collection at the set of pickup locations.

10. The method of claim 9, further comprising:
communicating, by the application server, the set of products and the set of pickup locations to the user device for recommending to the user; and
rendering, by the application server, a user interface on a display of the user device for recommending the identified set of products and the identified set of pickup locations to the user, wherein the recommended set of products and the recommended set of pickup locations are selectable by the user.

11. The method of claim 1, wherein the order request is further indicative of a pickup time for collecting the first product from the first pickup location, and wherein the first product is delivered to the first pickup location prior to the pickup time.

12. A system for facilitating in-transit purchase of products, the system comprising:
an application server configured to:
receive, from a user device of a user, route information of a route being traversed by the user in a transport vehicle and a current location of the transport vehicle on the route;
recommend, to the user by way of the user device, a set of products available for purchase and a set of pickup locations on the route for collecting the set of products, wherein the set of products and the set of pickup locations are recommended based on the received route information and the received current location;
receive an order request from the user device, wherein the order request is indicative of a first product selected by the user from the set of products for purchase, a first pickup location selected by the user from the set of pickup locations for collecting the first product, and an identifier of a radio frequency (RF) tag placed in the transport vehicle;
initiate, upon acceptance of the received order request, blocking of a transaction amount associated with the first product from a first payment account that is linked to the identifier; and
initiate deduction of the blocked transaction amount from the first payment account when the transport vehicle is detected at the first pickup location and the first product is delivered to the first pickup location, wherein the first product is collected by the user from the first pickup location.

13. The system of claim 12, wherein the first pickup location is a toll collection station.

14. The system of claim 13, wherein the application server is further configured to:
initiate a deduction of a toll fee amount from the first payment account, in addition to the blocked transaction amount; and
initiate a transfer of the deducted transaction amount and the deducted toll fee amount to a second payment account of a merchant associated with the first product and a third payment account of the toll collection station, respectively.

15. The system of claim 13, wherein the application server is further configured to:
communicate, to a toll server associated with the first pickup location, the identifier of the RF tag upon blocking of the transaction amount from the first payment account; and
receive, from the toll server, a notification when the transport vehicle is detected at the first pickup location by an RF reader at the first pickup location, and wherein the transport vehicle is detected at the first pickup location by the RF reader based on the identifier communicated to the toll server.

16. The system of claim 12, wherein the application server is further configured to receive a notification from the user device when a location of the user device corresponds to the first pickup location, and wherein the notification indicates the detection of the transport vehicle at the first pickup location.

17. The system of claim 12, wherein the application server is further configured to:
communicate, the received order request, to a merchant server of a merchant for delivering the first product to the first pickup location; and
receive, from the merchant server, a response indicating the acceptance of the order request by the merchant.

18. The system of claim 12, wherein when the first product is selected for purchase by the user by way of the user device, an RF reader placed in the transport vehicle is activated for reading the identifier of the RF tag, and wherein the identifier read by the RF reader is included in the order request.

19. The system of claim 12, wherein the application server is further configured to host a service application that is executable on the user device, and wherein the order request is initiated through the service application.

20. The system of claim 12, wherein the application server is further configured to identify, based on the route information, the set of pickup locations on the route and the set of products that are available for collection at the set of pickup locations.
